(19) United States
(12) Patent Application Publication
(10) Pub. No.: US 2024/0092166 A1
(43) Pub. Date: Mar. 21, 2024

(54) POWER TRANSMISSION ASSEMBLY AND VEHICLE COMPRISING THIS ASSEMBLY

(71) Applicant: IDEE SERVICES, EVECQUEMONT (FR)

(72) Inventor: Luc MICHEL, EVECQUEMONT (FR)

(73) Assignee: IDEE SERVICES, EVECQUEMONT (FR)

(21) Appl. No.: 17/768,179

(22) PCT Filed: Oct. 1, 2020
(86) PCT No.: PCT/FR2020/051727

§ 371 Date: Apr. 11, 2022

(30) Foreign Application Priority Data
Oct. 11, 2019 (FR) FR1911319

(51) Int. Cl. B60K 17/356; B60K 1/00; B60K 1/02; B60K 17/02; B60K 17/344; B60K 17/354; F16H 37/08; F16H 48/40; H02K 1/18; H02K 1/20; H02K 7/116; H02K 11/33

(52) U.S. Cl. CPC B60K 17/356; B60K 1/00; B60K 1/02; B60K 17/02; B60K 17/344; B60K 17/354; F16H 37/0813; F16H 48/40; H02K 1/187; H02K 1/20; H02K 7/116; H02K 11/33; B60K 2001/001; B60K 2001/006; B60K 6/48

(57) ABSTRACT

Power transmission assembly for a four-wheel drive vehicle including an electric machine, a gear reducer and a coupler connected to the gear reducer. The electric machine is an inverted machine in which the rotor is radially outside the stator with respect to the rotation axis of this electric machine.

### TECHNICAL FIELD

The present invention relates to a power transmission assembly for producing an electric vehicle or a hybrid vehicle.

### STATE OF THE ART

More particularly, the invention relates to a power transmission assembly for producing an electric vehicle or a hybrid vehicle (comprising a combustion engine and an electric motor). For example, the power transmission assembly makes it possible to transform a combustion vehicle into a hybrid vehicle or to transform a combustion vehicle into an electric vehicle.

For example, the power transmission assembly makes it possible to produce a four-wheel drive vehicle or to transform a two-wheel drive vehicle into a four-wheel drive vehicle. For example, the power transmission assembly makes it possible to transform a vehicle with a combustion engine which actuates the front axle (front-wheel drive type vehicle having two driving wheels at the front) into a four-wheel drive vehicle in which an electrical motor of this assembly is intended to be directly or indirectly linked to the rear axle of this vehicle. Conversely, it is possible to transform a combustion vehicle of the rear-wheel drive type into a four-wheel drive vehicle, the power transmission assembly then being directly or indirectly linked to the front axle of the vehicle.

In particular, the power transmission assembly comprises:
an electric machine comprising a stator fixed relative to the vehicle and a rotor movable in rotation relative to a rotation axis of said electric machine,
a gear reducer connected to the rotor of the electric machine, said gear reducer comprising a first pinion connected to the rotor and a crown gear (105b), the first pinion and the crown gear being 45° bevel pinions, arranged at 90° from each other, and
a transmission element linked to the crown gear of the gear reducer, to transmit the motive power and the rotation of the electric machine to other elements of the vehicle or conversely, and in particular to one or several wheels.

An electric machine can be led to be in an electric motor mode in which the electric power is transformed into rotational mechanical power, or conversely in an electric generator mode in which the rotational mechanical power is transformed into electric power. In the latter case, the machine is transformed into a brake with energy recovery in electrical form, wherein this electrical energy can of course be stored in the vehicle batteries.

For example, U.S. Pat. No. 8,672,068 proposes a power transmission assembly of this type.

This assembly is directly installed in the rear axle, and the rotation axis of the electric motor is coaxial with the transverse shaft of the rear axle structure (in French:

“pont arriëre”) of the vehicle.

This architecture complicates the setup of the rear axle in the volume available at the vehicle rear, and requires this rear axle to have a particular design.

### DISCLOSURE OF THE INVENTION

The purpose of the present disclosure is to propose a more modular solution for setting up an electric machine (electric motor/generator) in a vehicle, and for example at a front and/or rear axle of the vehicle.

To this end, the present disclosure relates to a power transmission assembly in which:
the electric machine is an inverted machine in which the rotor is radially outside the stator with respect to the rotation axis of the electric machine, and in which:
the stator of the electric machine comprises a stator body provided with windings on the outer periphery of said stator, and an annular cavity between the windings and the rotation axis, and wherein at least a part of the gear reducer is housed in the annular cavity with the first pinion completely included in the annular cavity, and a part of the crown gear which enters the annular cavity.

The electric machine of the inverted type, with the rotor on the outside, makes it possible to increase the torque of this electric machine at low rotation speed, and makes it possible to achieve a reduced size. Thus, the electric machine is better suited to a low-speed operating mode.

In addition, a power transmission assembly is obtained which is more compact than in the prior art (at equivalent power), and therefore easier to incorporate when motorizing a vehicle front and/or rear axle.

The installation of the assembly on the vehicle is then easier, in particular when it is a question of modifying a two-wheel drive series vehicle to transform it into a four-wheel drive vehicle or to transform a combustion vehicle into an electric vehicle or to transform a combustion vehicle into a hybrid vehicle. Indeed, the installation can be carried out by modifying few elements of this vehicle.

In addition, the electric machine of this power transmission assembly can:
either assist the combustion engine in the electric motor mode,
either slow the vehicle down in the electric generator mode, for example while recharging batteries.

Thanks to such operating in which the electric machine is led as a brake or as a support of a main motor such as a combustion engine, it is possible to optimize the operation of this combustion engine in operation. It is also possible to reduce the size thereof. Substantial energy savings can therefore be achieved.

In various embodiments of the power transmission assembly according to the present disclosure, one and/or the other of the following arrangements can possibly be used.

According to an aspect, the electric machine has the shape of a cylinder with a diameter greater than twice the height thereof.

According to an aspect, the first pinion has recessed shape in such a way that this first pinion at least partially surrounds a bearing of the stator.

According to an aspect, the assembly further comprises a coupler connected between the crown gear of the gear reducer and the transmission element, the coupler being adapted to switch between a coupled state in which the electric machine can actuate the transmission element in rotation and an uncoupled state in which the electrical machine cannot actuate the transmission element.

Thanks to this coupler, the electric machine can be uncoupled from the transmission element, and thus for example from the rear axle. It is then possible to restrict the use of this electric machine to certain operating modes of the vehicle, for example to low speeds. Energy losses are thus avoided outside this operating mode, and the general yield of the vehicle is improved.

According to an aspect, the rotor comprises:
a lateral flange which extends radially from the rotation axis, and
a cylindrical part carrying magnets having alternating polarities in the circumferential direction of this cylindrical part, said magnets facing the windings of the stator.

According to an aspect, the gear reducer consists of two bevel pinions, a first pinion integral with the rotor and a crown gear integral with the coupler.

According to an aspect, the assembly further comprises a support plate fixed to the stator, said support plate comprising an opening through which at least a part of the gear reducer passes.

According to an aspect, the support plate comprises at least one electrical passage adapted to let electrical supply conductors for supplying the stator through, and at least one fluid passage adapted to form a cooling channel of the stator by circulation of a fluid.

According to an aspect, the assembly further included a power electronics device for supplying the stator, said power electronics device being fixed to the support plate.

According to an aspect, the coupler is a dog coupling or a clutch, said coupler being actuated by mechanical, hydraulic or electrical action.

According to an aspect, the assembly further comprises:
a second coupler linked to the transmission element, and
a second gear reducer connected to the second coupler.

According to an aspect, the assembly further comprises a differential intended to be coupled to an axle of the vehicle, and the transmission element is mounted integral with the casing of the differential.

According to an aspect, the support plate comprises a first side on which the electrical machine is fixed and a second side on which the differential is fixed.

According to an aspect, the transmission element is mounted integral with a transfer shaft intended to transmit power between a first motor of the vehicle and a differential of a rear axle of the vehicle.

The disclosure also relates to a vehicle comprising
a front axle,
a rear axle, and
a power transmission assembly of the aforementioned type, the transmission element of this assembly being directly or indirectly linked to the vehicle front axle and/or rear axle.

In various embodiments of the vehicle according to the present disclosure, one and/or the other of the following arrangements can possibly be used.

In an aspect, the front axle is coupled to a first motor, and the transmission assembly is linked to the rear axle so as to obtain a four-wheel drive vehicle.

In an aspect, the rear axle is coupled to a first motor, and the transmission assembly is linked to the front axle so as to obtain a four-wheel drive vehicle.

According to an aspect, the rotation axis of the electric machine is parallel to the vehicle vertical axis.

According to an aspect, the electric machine is housed in a space reserved for a spare wheel under the vehicle chassis.

In an aspect, the assembly further comprises a coupler, and the coupler is placed in an uncoupled state if the speed of the vehicle is greater than a limit speed, adapted to the operating mode of the vehicle.

### BRIEF DESCRIPTION OF THE DRAWINGS

Other features and advantages of the disclosure will become apparent from the description hereinafter of one embodiment thereof, given by way of non-limiting example, with reference to the appended drawings.

In the drawings:

FIG. 1 is a schematic top view of a vehicle;

FIG. 2 is a schematic view of a first embodiment of a power transmission;

FIGS. 3 and 4 are views of an implementation example of the power transmission of FIG. 2;

FIG. 5 is a schematic view of a second embodiment of a power transmission; and

FIG. 6 is a schematic view of a third embodiment of a power transmission.

In the various figures, the same numerical references designate identical or similar elements.

### DETAILED DESCRIPTION

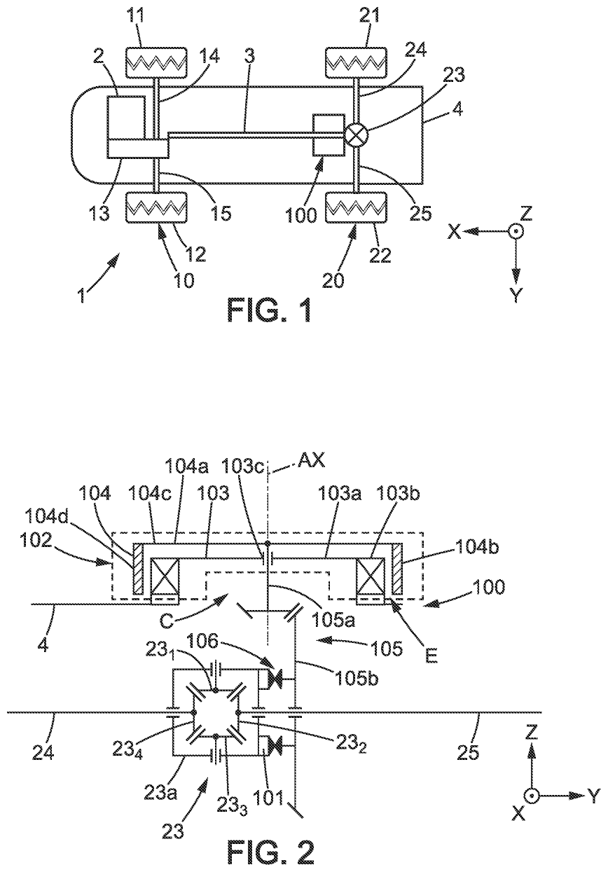

FIG. 1 is a schematic top view of a vehicle 1 according to the present disclosure. This vehicle 1 is, for example, a two-axle vehicle, comprising:
a chassis 4,
a front axle 10 coupled to a first motor 2,
a rear axle 20, and
a power transmission assembly 100 comprising a transmission element 101 directly or indirectly linked to the rear axle 20.

In this example shown in FIG. 1, the front axle 10 is coupled to a first motor 2. However, all the variants mentioned in the introduction are possible.

The first motor 2 is for example an internal combustion engine, or possibly a first electric motor.

The front axle 10 includes a wheel on the right 11, a wheel on the left 12, and a traction unit 13 which couples the first motor to the wheels on the right and on the left 11, 12 via traction shafts 14, 15. The traction unit 13 includes for example a gearbox, and a differential device for distributing the power between the wheels on the right and on the left of the front axle 10.

The rear axle 20 includes a wheel on the right 21, a wheel on the left 22, and a differential 23 for distributing power between the wheels on the right and on the left 21, 22 of the rear axle 20, via propulsion shafts 24, 25.

Optionally, the vehicle 1 is initially a traditional type four-wheel drive vehicle, that is to say a four-wheel drive vehicle powered by the first motor 2. The vehicle further comprises a transfer shaft 3 which also couples the traction unit. 13 to the rear axle 20 so as to deliver part of the motive power of the first motor 2 to the wheels of the rear axle 20. This transfer shaft 3 is usually coupled to a meshing crown gear of the differential 23 by a bevel pinion.

Other mechanical elements are usually implemented in such a mechanical chain, in particular, for example, universal joints to allow wheel movements, and various other couplings and mechanisms . . .

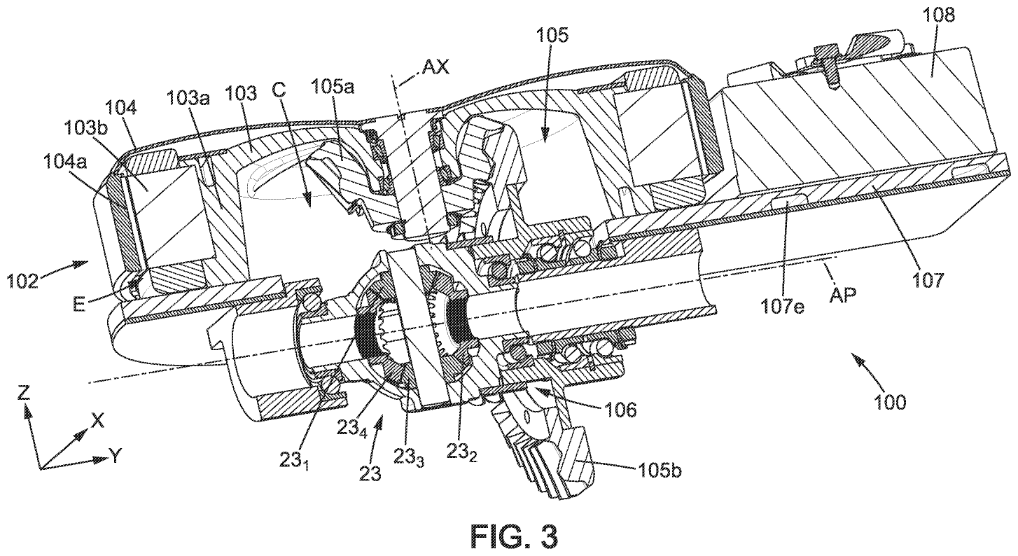

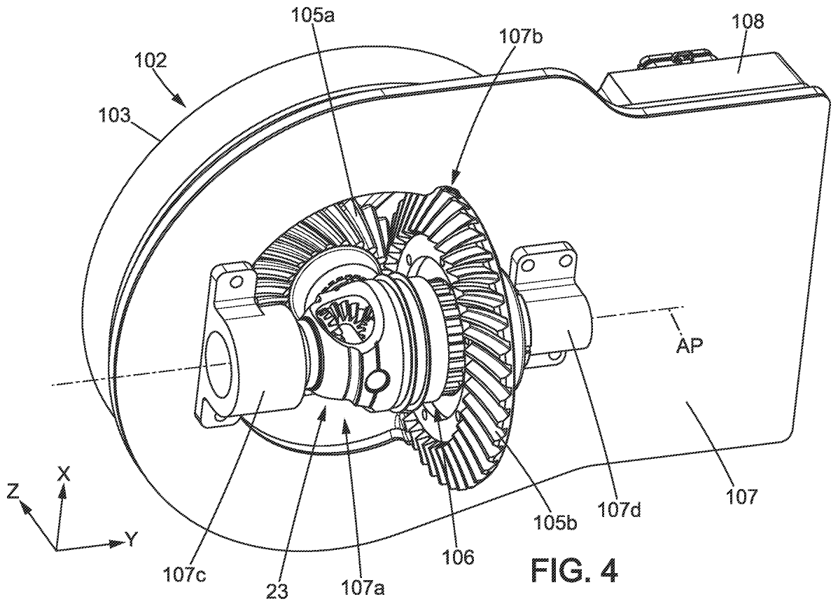

FIGS. 2 to 4 show a first embodiment of a power transmission assembly 100 according to the present disclosure, wherein the transmission element 101 is linked to the differential 23 of the vehicle 1. FIG. 2 is a schematic view for understanding the operation, and FIGS. 3 and 4 show an implementation example of this embodiment of the power transmission assembly 100.

In FIG. 2, the differential 23 is shown as it is usually made for a rear axle 20 of a vehicle, but it could have another shape. This differential 23 comprises a casing 23a which encloses four bevel pinions 231, 232, 233, 234 arranged at 90° to one another, and which mesh two by two. Two bevel pinions 231, 233 facing each other are articulated free in rotation with respect to the casing 23a. The other two bevel pinions 232, 234 are respectively linked to the propulsion shafts 25, 24 of the rear axle 20. The casing 23a of the differential is often provided with an input crown gear (a bevel pinion having a larger diameter than casing 23a to provide a primary power input, i.e., to introduce motive power.

Here, the casing 23a is integral with the transmission element 101 of the power transmission assembly 100.

The power transmission assembly 100 then includes:
an electric machine 102 comprising a stator 103 fixed relative to the chassis 4 of the vehicle 1 and a rotor 104 movable in rotation relative to a rotation axis AX of the electric machine 102, and
a gear reducer 105 connected to the rotor 104 of the electric machine.

The gear reducer 105 is itself composed of a first pinion 105a connected to the rotor 104 and of a crown gear 105b. For example, the first pinion 105a and the crown gear 105b are 45° bevel pinions, disposed at 90° from each other. The gear reducer 105 corresponds to the primary input of the transmission assembly.

The crown gear 105b is then in pivot link with a shaft, such as for example one of the propulsion shafts 24, 25.

The electric machine 102 of this transmission assembly 100 according to the disclosure is in fact for example capable of operating in motor mode and/or in electric generator mode. This electric machine 102 is advantageously an inverted machine in which the rotor 104 is radially outside the stator 103 with respect to the rotation axis AX.

Thanks to these arrangements, the transmission assembly 100 is a compact device, which is more modular than the hybrid axles of the prior art. This transmission assembly 100 is capable of transmitting electric motive power to the rear axle 20 with little loss and with a high torque.

The electric machine 102 is an electric motor and/or an electric generator. For example, the electric machine in motor mode is capable of assisting a first (combustion) motor of the vehicle. For example, the electric machine in generator mode is capable of slowing the vehicle down, possibly while recharging batteries. This electric machine 102 is advantageously a machine of the synchronous type.

The stator 103 comprises a stator body 103a equipped with windings 103b on the outer periphery of this stator 103, and a bearing 103c on the rotation axis AX of the electric machine. As shown in the figure, the bearing 103c is for example rotationally articulated around the shaft of the first pinion 105a, the first pinion 105a being itself rotationally articulated around the rotation axis AX, directly or indirectly with respect to the chassis 4 of the vehicle (not shown).

The stator 103 thus comprises an annular cavity C between the windings 103h and the rotation axis AX. A part of the gear reducer 105 is for example housed inside this annular cavity C. In the presented embodiment, the first pinion 105a can be completely included in this annular cavity C. A part of the ring gear 105b can penetrate this annular cavity C. In this way, the transmission assembly 100 is very compact.

The electric machine 102 has a substantially cylinder-shape. For example, this cylinder shape is very flat with a diameter greater than twice the height thereof, and for example a diameter greater than three or four times the height thereof. The annular cavity C then has a shape ratio (cavity diameter×cavity height) similar or identical to that of electric machine 102. Thanks to this arrangement, the first pinion 105a can be more easily fully included in the annular cavity C. The ring gear 105b can also more easily penetrate at least partially in the annular cavity C.

Thanks to this flat shape, the electric machine can be set up on the vehicle above the differential 23, as shown in the figures, i.e., between the differential 23 and the vehicle chassis, with the rotation axis AX parallel to the vertical axis Z. The electric machine 102 is well housed and protected under the vehicle, and it does not affect the ground clearance.

Furthermore, the ring gear 105b deeply penetrates into annular cavity C; the side flanges of the stator 103 and of the rotor 104 of the electric machine 102 have a small thickness so that in fact the electric machine 102 does not take up much more space in the vertical direction Z under the vehicle than the ring gear 105b linked to the differential 23. In other words, the transmission assembly 100 and the electric machine 102 are compact, use little volume under the vehicle and can easily be set up on any vehicle type.

The first pinion 105a of the reducer gear 105 also optionally has a recessed shape in such a way that this first pinion 105a at least partially surrounds the bearing 103c of the stator. Thanks to this arrangement, the first pinion 105a can be placed completely inside the annular cavity C and even housed very deep in the annular cavity C. The ring gear 105h could then deeply penetrate in the annular cavity C. The transmission assembly 100 and the electric machine 102 are all the more compact, use little space under the vehicle and can easily be set up on any type, of vehicle.

The rotor 104 comprises a rotor body 104a equipped with magnets 104b coming opposite the windings 103b of the stator. The rotor body 104a comprises for example a lateral flange 104c which extends radially from the rotation axis AX, and an outer cylindrical part. 104d carrying the magnets 104b. The magnets 104b are positioned on the inner periphery of said cylindrical part 104d to face the windings 103h, and are positioned with alternating polarities along the circumferential direction of the circumference of this cylindrical part 104d.

Thus, the windings 103b are located in the internal part of the electric machine 102 (close to the rotation axis AX) and the magnets 104h are located in the external part of the electric machine 102 (outside the stator). However, the windings 103b have a radial size (in a direction perpendicular to the rotation axis AX) greater than the magnets 104b. The air gap E of the electric machine is the cylindrical area between stator 103 and rotor 104. At a constant air gap diameter E, an electric machine of the inverted type then has a smaller radial size and/or a higher torque compared to a non-inverted electric machine.

Thus, thanks to this arrangement, the electric machine of the present disclosure is more efficient, in particular with respect to its use in a four-wheel drive vehicle 1 for a low running speed of said vehicle.

In addition, the transmission assembly 100 may include a coupler 106 between the gear reducer 105 (the ring gear 105b) and the transmission element 101.

The coupler 106 is adapted to switch between a coupled state in which the electric machine 102 can actuate the transmission element 101 in rotation (via the gear reducer 105 and the coupler 106) and an uncoupled state in which the electric machine 102 cannot actuate the transmission element 101.

The coupler 106 is therefore a mechanical coupling element between two elements, and can be led. This coupler is for example a dog coupling system or a clutch. The coupler 106 can be actuated by mechanical, hydraulic or electrical action (not shown in FIG. 2).

This coupler thus makes it possible to uncouple the transmission assembly 100 when it is not useful for running the vehicle, which makes it possible to improve the overall yield by eliminating the mechanical losses of this assembly.

Indeed, the electrical machine 102 of the transmission assembly 100 does not operate, either as a motor or as a brake when the coupler 106 is in the uncoupled state. This prevents the electric machine 102 from unnecessarily rotating in operating modes for which the electric machine is not useful.

Possibly, when the vehicle is provided with several transmission assemblies 100, it is possible to mechanically couple or uncouple one or several of them, according to needs. Thus, the power transmission of the vehicle is more efficient and much more modular than the hybrid axle devices of the prior art.

In the exemplary embodiment of FIGS. 3 and 4, the reference numerals designate identical or similar elements to those of FIG. 2, but new details or variants of the power transmission assembly 100 are visible.

In these figures, the propulsion shafts 24, 25 are not visible. They must be placed on the propulsion axis AP.

These figures show that the power transmission assembly 100 further comprises a support plate 107 on which the stator 103 of the electric machine 102 is fixed.

This support plate 107 comprises an opening 107a through which at least part of the gear reducer 105 passes:

The ring gear 105b having as an axis, the propulsion axis AP perpendicular to the rotation axis AX of the rotor 104, passes through this opening 107a. The opening 107a possibly includes a cutout 107b adapted to the shape of the ring gear 105b for it to pass through.

Thus, the support plate 107 comprises a first side on which the electric machine 102 is fixed, and a second side opposite the first side on which the differential 23 is fixed, for example via supports 107c, 107d comprising bearings in which the propulsion shafts are rotatably mounted.

In this example, the power transmission assembly 100 further comprises a power electronics device 108 enclosed in an assembly box fixed to the support plate 107, for example on the same side as the electric machine 102 (the first side).

The support plate 107 then comprises at least one electrical passage (not shown) adapted to let electrical supply conductors for supplying the stator 103 of the electrical machine through.

According to variants, the support plate 107 also comprises at least one fluid passage 107e adapted to form a cooling channel. This channel and the fluid make it possible to cool down the stator and/or the power electronics device 108. Pumping devices are led to control the circulation of this fluid in the fluid passage.

In these figures, the power electronics device 108 is positioned beside the electric machine, in the Y direction, which is the direction of the propulsion axis AP.

This power electronics device 108 can possibly be placed on the second side, for example around the differential 23.

According to variants, this power electronics device 108 is placed in the cavity C on the stator body 103 or in the support plate 107.

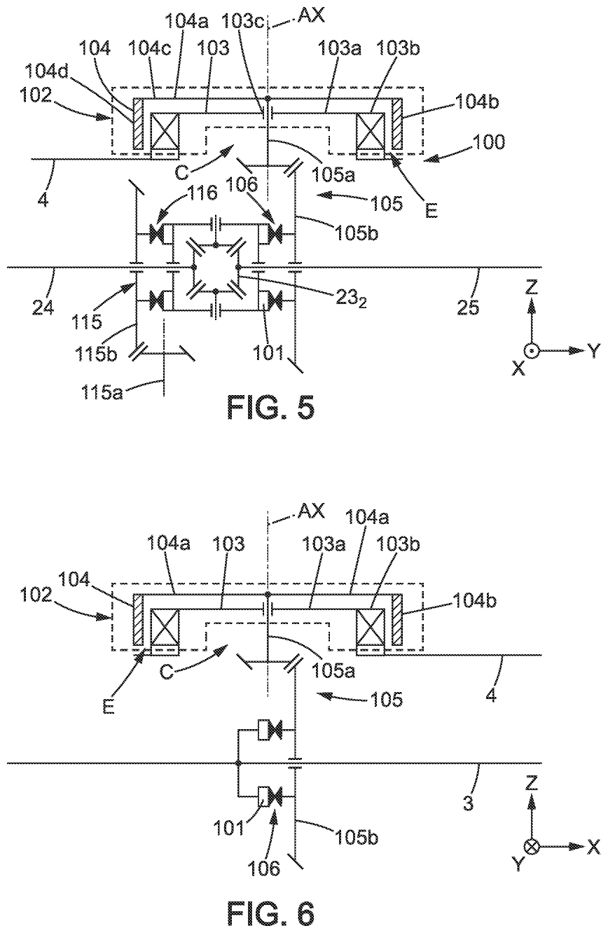

FIG. 5 shows a schematic view of a second embodiment of a power transmission assembly 100 according to the present disclosure, further comprising:
a second coupler 116 linked directly or indirectly in an integral manner) to the transmission element 101, and
a second gear reducer 115 connected to the second coupler 116 to provide a secondary power input to the power transmission assembly 100.

The second gear reducer 115 is itself for example composed of a second ring gear 115b connected to the second coupler 115 and of a second pinion 115a. For example, the second pinion 115a and the second ring gear 115b are 45° bevel pinions, disposed at 90° from each other, as shown in the figure.

The second pinion 115a is then for example connected to a shaft, such as a transfer shaft 3 to receive power from a first motor 2.

The second coupler 116 is adapted to switch between a coupled state in which the second gear reducer 115 can actuate the transmission element 101 in rotation and an uncoupled state in which the second gear reducer 115 cannot actuate the transmission element 101. The second coupler 116 is therefore a coupling element which can be led, such as coupler 106. It can be of the same type or of a different type.

It makes it possible to provide various operating modes to the power transmission assembly 100.

Thanks to these arrangements, the transmission assembly has a secondary power input. This power transmission assembly 100 can be incorporated in a vehicle in which this secondary input is moved by the first motor 2, and the electric machine 102 makes it possible to replace or supplement this driving power.

Thus, the coupler 106 makes it possible to couple the electric machine and the second coupler 116 makes it possible to couple the first motor 2. The power transmission assembly 100 can be:
either an electrical power transmission assembly if only the coupler 106 is in the coupled state,
either a power transmission assembly of the first motor if only the second coupler 116 is in the coupled state,
either a combined power transmission assembly if the two couplers 106, 116 are in the coupled state.

FIG. 6 shows a schematic view of a third embodiment of a power transmission assembly 100 according to the present disclosure, wherein the transmission element 101 is linked to the transfer shaft 3 of the vehicle 1.

In this figure, the reference numerals designate elements which are identical or similar to those of the preceding figures.

The power transmission assembly 100 according to the disclosure comprises the same elements, and in particular an electric machine 102, and a gear reducer 105. The transmission element 101 is here made secured to the transfer shaft 3. The electric machine 102 is an inverted machine in which the rotor 104 is radially outside the stator 103 with respect to the rotation axis AX.

Thanks to these arrangements, the transmission assembly 100 is a compact device, and capable of transmitting electrical motive power to the transfer shaft 3 with little loss and with a high torque.

Likewise, the electric motor 102 is an electric motor and/or an electric generator. For example, the electric machine in motor mode is capable of assisting a first (combustion) motor of the vehicle. For example, the electric machine in generator mode is capable of slowing the vehicle down, possibly while recharging batteries. This electric machine is advantageously a machine of the synchronous type. The stator comprises a stator body 103a provided with windings 103b on the outer periphery of said stator, and includes an annular cavity C between the windings 103b and the rotation axis AX. A part of the gear reducer 105 is housed in this cavity C. In particular, the first pinion 105a can be completely included in the annular cavity C, and the ring gear 105b penetrates this annular cavity C. Thus, the transmission assembly 100 is very compact. The rotor 104 comprises a rotor body 104a equipped with magnets 104b, these magnets coming opposite the windings 103b.

Thus, thanks to this arrangement, the electric machine 102 of the present disclosure is more efficient, in particular with respect to its use in a four-wheel drive vehicle 1 for a low running speed of said vehicle.

Possibly, the transmission assembly 100 includes a coupler 106 which has the same function as in the first embodiment, which makes it possible to improve the overall yield of the vehicle.

Thus, the transmission assembly 100 according to the embodiments presented above can be incorporated into any vehicle type. For example, it can be incorporated into a four-wheel drive vehicle, by being linked directly (first and second embodiments) or indirectly (third embodiment) to the rear axle 20 of this vehicle.

According to a variant, thanks to the compactness of the electric machine 102 (in particular the compactness thereof in the direction of the rotation axis AX), the electric machine is oriented on the vehicle in a direction parallel to the vertical axis Z of the vehicle, i.e., so that the rotation axis AX is parallel to this vertical axis Z. This arrangement differs completely from the setups of electric motors from the prior art, which are usually oriented on the transverse Y or longitudinal X axis of vehicle 1.

Thanks to its flat and compact shape, the electric machine 102 can therefore be set up or housed under the vehicle between the differential 23 and the vehicle chassis, with its rotation axis AX, in the vertical direction. In this set up, the electric machine 102 does not surround the transfer shaft 3, nor a traction shaft 14, or a propulsion shaft 24, 25. This set up is therefore more modular.

In addition, it is then possible to house the electric machine 102 in a space of the chassis 4 usually reserved for a spare wheel.

Thus, it is possible to mount a power transmission assembly 100 in a series vehicle (not a four-wheel drive vehicle) to transform it into a four-wheel drive vehicle or to transform a thermal vehicle into an electric vehicle or to transform a thermal vehicle into a hybrid vehicle with alternate or combined operation in order to optimize the yield of the internal combustion engine. The two wheels of the front axle 10 being motorized by the first motor of the vehicle, and the two wheels of the rear axle 20 being then motorized by the electric machine 102 of the power transmission assembly 100.

Lastly, the coupler 106 will advantageously be led by the vehicle 1 (the electronic device thereof) so that it is in an uncoupled state if the vehicle speed is greater than a speed limit. This speed limit is adapted to the operating mode of the vehicle. It may for example be 50 km or 110 km/h.

For example, the speed limit is 50 km/h. Thus, the vehicle 1 is possibly in a four-wheel drive mode only below this speed limit. This corresponds well to the usual use of the four-wheel drive mode. At higher speed, the vehicle 1 is in a two-wheel drive mode (those wheels of the front axle 10), but thanks to the coupler 106, the power transmission 100 does not hinder the yield of the vehicle 1 in this operating mode.

For example, the speed limit is 110 km/h. Thus, the vehicle 1 is possibly in an electric or hybrid mode only below this speed limit. At higher speed, the vehicle 1 is in a thermal mode, but thanks to the coupler 106, the power transmission 100 does not hinder the yield of the vehicle 1 in this operating mode.

1. A Power transmission assembly for a vehicle comprising:
an electric machine comprising a stator fixed relative to the vehicle and a rotor movable in rotation relative to a rotation axis of said electric machine,
a gear reducer connected to the rotor of the electric machine, said gear reducer comprising a first pinion connected to the rotor and a ring gear, the first pinion and the ring gear being 45° bevel pinions, arranged at 90° from each other, and
a transmission element linked to the ring gear of the gear reducer, wherein:
the electric machine is an inverted machine in which the rotor is radially outside the stator with respect to the rotation axis of the electric machine,
the stator of the electric machine comprises a stator body provided with windings on the outer periphery of said stator, and an annular cavity between the windings and the rotation axis,
the assembly being characterized in that at least a part of the gear reducer is housed in the annular cavity with the first pinion completely included in the annular cavity, and a part of the ring gear which enters the annular cavity.

2. The assembly according to claim 1, wherein the electric machine has the shape of a cylinder with a diameter greater than twice the height thereof.

3. The assembly according to claim 1, wherein the first pinion has a recessed shape in such a way that this first pinion at least partially surrounds a bearing of the stator.

3. The assembly according to claim 1, wherein the first pinion has a recessed shape in such a way that this first pinion at least partially surrounds a bearing of the stator.

4. The assembly according to claim 1, further comprising:
a coupler connected between the ring gear of the gear reducer and the transmission element, the coupler being adapted to switch between a coupled state in which the electric machine can actuate the transmission element in rotation and an uncoupled state in which the electrical machine cannot actuate the transmission element.

5. The assembly according to claim 1, wherein the rotor comprises;
a lateral flange which extends radially from the rotation axis, and
a cylindrical part carrying magnets having alternating polarities in the circumferential direction of this cylindrical part, said magnets facing the windings of the stator.

6. The assembly according to claim 4, wherein the gear reducer consists of two bevel pinions, a first pinion integral with the rotor and a ring gear integral with the coupler.

7. The assembly according to claim 1, further comprising a support plate fixed to the stator, said support plate comprising an opening through which at least a part of the gear reducer passes.

8. The assembly according to claim 7, wherein the support plate comprises at least one electrical passage adapted to let electrical supply conductors supplying the stator through, and at least one fluid passage adapted to form a cooling channel of the stator by circulation of a fluid.

10. The assembly according to claim 1, wherein the coupler is a dog coupling or a clutch, said coupler being actuated by mechanical, hydraulic or electrical action.

11. The assembly according to claim 1, further comprising:
a second coupler linked to the transmission element, and
a second gear reducer connected to the second coupler.

12. The according to claim 1, further comprising a differential intended to be coupled to an axle of the vehicle, and in which the transmission element is mounted integral with the casing of the differential.

13. The assembly according to claim 7, wherein the support plate comprises a first side on which the electrical machine is fixed and a second side on which the differential is fixed.

14. The assembly according to claim 1, wherein the transmission element is mounted integral with a transfer shaft intended to transmit power between a first motor of the vehicle and a differential of a rear axle of the vehicle.

15. The vehicle comprising:
a front axle,
a rear axle, an
a power transmission assembly according to claim 1, the transmission element of this assembly being directly or indirectly linked to the vehicle front axle and/or rear axle.

16. The vehicle according to claim 15, wherein:
the front axle is coupled to a first motor, and the transmission assembly is linked to the rear axle so as to obtain a four-wheel drive vehicle, or

16. The vehicle according to claim 15, wherein:
the front axle is coupled to a first motor, and the transmission assembly is linked to the rear axle so as to obtain a four-wheel drive vehicle, or
the rear axle is coupled to a first motor, and the transmission assembly is linked to the front axle so as to obtain a four-wheel drive vehicle.

17. A vehicle according to claim 15, wherein the rotation axis of the electric machine is parallel to the vehicle vertical axis.

18. The vehicle claim 15, wherein the electric machine is housed in a space reserved for a spare wheel under the vehicle chassis.

19. The vehicle according to claim 15, wherein the assembly further comprises a coupler according to claim 2, and the coupler is placed in an uncoupled state if the speed of the vehicle is greater than a limit speed, adapted to the operating mode of the vehicle.
